(19) United States
(12) Patent Application Publication
(10) Pub. No.: US 2010/0051384 A1
(43) Pub. Date: Mar. 4, 2010

(54) Ladder Stabilizer

(76) Inventor: Eugene Currie, Mississauga (CA)

Correspondence Address: Nasser Ashgriz;Heydary Hamilton PC, Suite 1200, 439 University Ave., Toronto, ON, M5G 1Y8, CA

(21) Appl. No.: 12/202,527

(22) Filed: Sep. 2, 2008

(51) Int. Cl. E06C 7/06

(52) U.S. Cl. 182/107

(57) ABSTRACT

A ladder stabilizer for securing a ladder to a ground surface is disclosed. The stabilizer comprises of a rung holder and a substantially flat spike having a pointed end. The spike is connected to the rung holder and extends towards the ground. The rung holder is a substantially rectangular part with open bottom to receive a ladder rung, which engages with the rung of a ladder once the spike is forced into the ground with a foot support attachment which is rigidly fixed to the body of the rung holder.

### FIELD OF THE INVENTION

The present invention is a ladder stabilizer which makes a ladder stable and prevents it from shifting and falling.

### BACKGROUND OF THE INVENTION

The present invention has been developed in order to allow individuals utilizing straight ladders and extension ladders that are placed upon the ground and against a structure, such as a house, garage, trailer, etc., to operate the ladder in a safe manner. The present invention relates to a ladder stabilizer device, the principal of which is to engage the ladder with the ground. The stabilizer hooks onto the ladder rung and is pressed into the ground, keeping the ladder stable. The present invention could be utilized by anyone using ladders, including commercial workers such as trades people, general maintenance personnel, construction laborers, line installers, and window washers.

Numerous injuries are reported annually that relate to a fall from a ladder. In one province of Canada (Ontario), there were 8,366 emergency room visits in 2004-2005 from ladder spills. Many of these injuries are very serious. Such injuries may be preventable by making sure that the ladder is stable and does not shift, move or fall.

Recognizing the issues with ladder stability, Wilkens patented a ladder attachment in 1894 (U.S. Pat. No. 530,374). Wilkens' ladder attachment pivotably attaches to the bottom of the ladder and has short studs for securing to the ground. It folds up against the ladder when not in use. Since the studs are always jutting out from the attachment near the end of the ladder, they can easily injure people while carrying the ladder. Since, Wilkens invention, there have been many other ladder stabilizers. The stabilizers that engage to the ground and are more relevant to the present invention are briefly described below.

U.S. Pat. No. 2,523,535 issued to Little discloses an adjustable ladder anchor. Little's ladder anchor comprises a two element shaft in which the elements telescopically engage one another. The first element has means for accepting a stake-like member to secure the ladder anchor to the ground. The second element has an “S”-shape element for engaging a round bottom rung of a ladder. Little's anchor does not provide side-to-side stability for the ladder, and since it extends away from the ladder, it may result in tripping hazards.

U.S. Pat. No. 5,054,579 issued to Moson discloses a ladder with an anchoring system that hooks over the bottom rung and is staked into the ground below the ladder to hold it in place. One embodiment of Moson's anchoring system comprises one or two pegs having either a “J” or “L” shape. The long leg of the peg is to be driven into the ground, while the shorter leg is for frictionally engaging the upper surface of the lowest rung of the ladder. However, due to the fact that the pegs do not completely engage the rung of the ladder, the possibility still exists of the ladder sliding away from the structure partially supporting same.

U.S. Pat. No. 5,337,856 issued to Fillers disclosed a U-shaped ladder anchoring pins for stabilizing a ladder that is hammered into the ground to stake down the bottom rung. For small ladder only one set of U-shaped pins is used, whereas, for ladders with wider rungs, two U-shaped pins are used.

U.S. Pat. No. 5,918,699 issued to Summers disclosed an anchoring system for a ladder that attached to the bottom rung of the ladder and is then staked into the ground. Summers invention is similar to that of Moson's with the difference that the two stakes are connected. However, there are still two staked which are inserted into the ground. In addition, the anchoring system engages the ladder from the front side of the ladder, and it is much wider than the ladder rung and does not tightly hold onto the rung.

U.S. Pat. No. 6,089,350 issued to Hankins discloses a ladder safety device that is hooked over the bottom rung of the ladder and has an extension with a stake that can be hammered into the ground. The location of the stake is away from the ladder rung, which may ‘not’ provide the desired stability.

The prior art taken either singly or in combination, is seen not to describe the instant invention as claimed. The present invention which comprises of a rung holder for engaging almost the full length of the ladder rung; a single flat contoured spike that is inserted into the ground; and a foot rest to push the spike into the ground is not seen in the prior art.

### SUMMARY OF THE INVENTION

The principal object of the present invention is to produce a ladder stabilizer which utilizes a single contoured spike with a substantially flat surface which extends into the ground to stabilize the ladder. A ladder may become unstable and fall backwards. A “flat” spike inserted into the ground prevents backward motion of the ladder and provides a high resistance to any backward angular moment generated by a climber on the ladder.

A ladder may also become unstable and fall sideways. It is yet another object of the invention to produce a ladder stabilizer with side-to-side stability by having a latter rung holder which tightly holds and covers almost all the rung to ensure stability. By supporting substantially the whole length of a ladder rung, the ladder becomes more resistance to any side to side angular moments generated by a climber.

Still another object of the invention is to increase the ladder stability and prevent backward movement of a ladder by providing an inverted U-shaped rung holder. This rung holder reduces the possibility of slippage and turning moment of the ladder.

It is a further object of this invention to provide such a stabilizing device that is both simple and quick to install and easy to remove from engagement with the ground and ladder by providing a broad, adequately strong, impact area to receive blows when driving the ladder anchor spike into the ground, and a pivotal handle for removing the ladder anchor spike and transporting the same in an easy and convenient manner.

These and other objects of the present invention will become readily apparent upon further review of the following specification and drawings. To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the figures, which illustrate, by way of example only, embodiments of the present invention,

FIG. 1 illustrates a perspective view of one embodiment of the ladder stabilizer.

FIG. 2 illustrates the ladder stabilizer attached to a ladder and inserted into the ground.

FIG. 3 illustrates the front view of the ladder stabilizer attached to a ladder having a foldable handle.

### DETAILED DESCRIPTION OF THE INVENTION

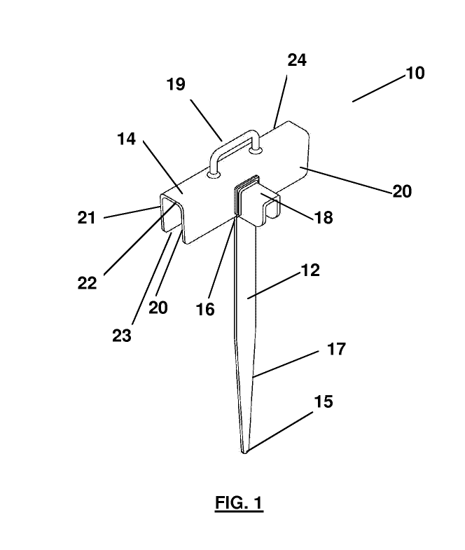

FIG. 1 illustrates a ladder stabilizing device 10, comprising a spike 12, and a ladder rung holder 14. Both the spike and the ladder rung are constructed from a high strength and rigid material, preferably steel or stainless steel. Spike 12 having a first end 15 and a second end 16 and a profile 17. The spike is preferably made of a flat sheet of metal having large enough thickness to prevent bending by forces generated by the movement of a ladder. The spike is preferably made of ¼ inch thick metal having at least 2 inches of width. The spike profile 17 is such that it makes it easy to insert it into the ground. The profile is substantially rectangular at the top and smoothly narrows to a pointy bottom for insertion into the ground. The flat spike makes it difficult for the ladder to fall from the back, which is the most dangerous fall. When a ladder becomes unstable, the angular momentum generated by a climber going backwards away from the structure has to be resisted. A flat spike inserted into the ground provides such resistance. The spike is attached to the ladder rung holder 14 at a junction 16. In the preferred embodiment of the device, the spike is welded to the rung holder. In another embodiment of the same device, the spike is connected to the holder using a hinge, allowing for the holder to move, and allowing for pivotably connecting the holder onto the rung (not shown here).

The ladder rung holder 14 has a substantially rectangular cross section having a front side 20, a back side 21, and a top side 22, whereas its bottom side 23 is open to receive the ladder rung. The ladder rung holder has a length 24 which is long enough to cover almost the entire length of the rung, leaving only a small part of the rung exposed on each side. The ladder rung holder 14 is preferably made of a high grade sheet metal bent to form an inverted U with squared corners. The rung holder of preferred embodiment is 12 or 14 inches in length depending on the ladder size. The rung holder has a flat top so that it can cover substantially the whole surface of a rung, and also allows for an individual to use the rung holder to climb the ladder.

The spike is placed next to the bottom rung of a ladder after the ladder is positioned, and it is inserted into the ground. The spike is forced into the ground until the rung holder of the stabilizer is tightly placed on top of the lowest rung of the ladder.

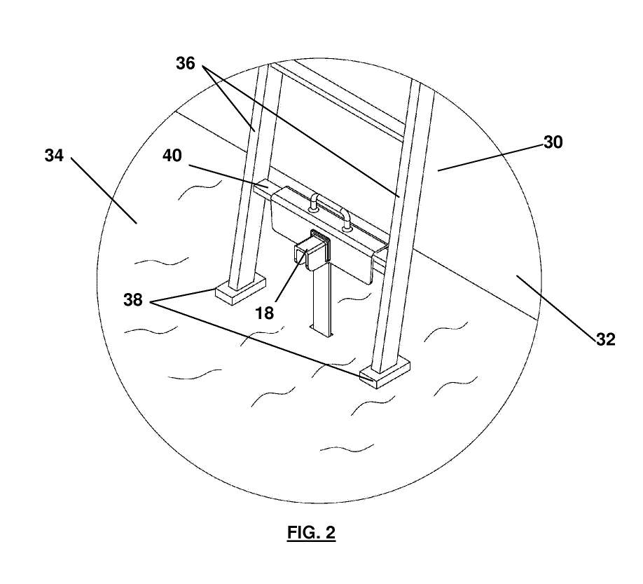

FIG. 2 illustrates the ladder stabilizer in use. A ladder 30 is leaned against a vertical structure 32, and is resting upon a ground surface 34. The ladder has a pair of side rails 36 and a pair of feet 38 which engage the ground surface 34 beneath each of the side rails 36. A lowest rung 40 extends between the side rails 36 and has a length defined as the distance between the rails 36.

Once the ladder is leaned against the structure 32 at a suitable angle, and the feet 38 are adjusted to make the ladder 30 as stable as possible, the ladder stabilizer 10 is used to further stabilize the ladder 30. The spike 10 is held next to the lowest rung and is inserted into the ground until the rung holder is fully engaged with the rung and spike cannot be further pushed into the ground. The foot support 18 can be used to push the spike hard into the ground.

After the attachment, the ladder would be securely anchored by the stabilizer and would be less likely to slip and shift. The length of the rung holder prevents the side-to-side tipping of the ladder. After use, the spike can be removed by a handle 19 on the top of the holder. In the embodiment of FIG. 1, the handle 19 is rigidly connected to the top of the rung holder. The handle can be used to carry the stabilizer and once it is used.

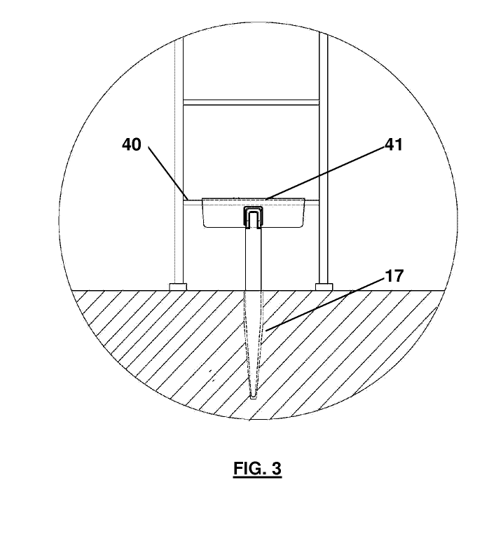

In another embodiment of the same invention, the handle can be pivotably connected to the rung holder. The handle 41 can be folded to provide a substantially flat surface for the climber to step on as shown in FIG. 3.

In another embodiment of the same invention, instead of a handle a hoop can be welded to the top of the holder (not shown here) so that a rope can be passed through it to pull the device out of the ground.

In another embodiment of the present invention, the width of the rung holder can be adjusted. Any adjustable means can be used. In the preferred embodiment, the rung holder is comprised of two L-shaped parts which can slide on top of each other and having a screw on each side of the length of the rung holder to tighten the L shapes to each other (not shown here).

It is to be understood that the present invention is not limited to the sole embodiment described above, but encompasses any and all embodiments within the scope of the following claims.

1. (canceled)

2. (canceled)

3. (canceled)

4. (canceled)

5. (canceled)

6. (canceled)

7. (canceled)

8. (canceled)

9. (canceled)

10. A ladder stabilizer, comprising:
a. a rung holder having a front side, a back side, and a top side, with an open bottom to receive the bottom rung of a ladder;
b. said front, back and top sides of the rung holder shaped and sized to cover said bottom rung;
c. a flat and rectangular shaped spike having a first pointy end to be inserted into the ground and a second end rigidly connected to the middle of the front side of the rung holder;
d. said flat spike having a width and a thickness, whereas said width being larger than said thickness;
e. a foot holder rigidly connected to the middle of the front side of the rung holder; and
f. a handle rigidly connected to the top side of the rung holder,
whereby the ladder is stabilized by setting the ladder stabilizer next to the rung of a ladder and forcing it into the ground until the rung holder engages onto the rung and the stabilizer is securely fixed into the ground.

11. The ladder stabilizer of claim 1, wherein said ladder stabilizer is made of at least a ¼ inch thick steel.

12. The ladder stabilizer of claim 1, wherein the width of said spike is at least 2 inches.

13. The ladder stabilizer of claim 1, wherein said rung holder comprising of a high grade sheet metal bent to form an inverted U with squared corners.

14. The ladder stabilizer of claim 1, wherein the length of the spike is at least two times the length of the rung holder.

15. The ladder stabilizer of claim 14, wherein said rung holder having a length of 12 or 14 inches, to cover ladders with 12 or 14 inches rungs.

16. A ladder stabilizer, comprising:
a. an adjustable length rung holder comprising of two L shaped sections that can slide on top of each other, whereby one side of said L shape section places on the top of the ladder rung, and the other side extends downwards in front of the ladder rung;
b. means to tightly fix the two sections, whereby the two sections are adjusted and fixed to cover the bottom rung of a ladder;
c. a flat and rectangular shaped spike having a first pointy end to be inserted into the ground and a second end rigidly connected to the middle of the rung holder;
d. said flat spike having a width and a thickness, whereas said width being larger than said thickness;
e. a foot holder rigidly connected to the middle of the front side of the rung holder; and
f. a handle rigidly connected to the top of the rung holder;
whereby the ladder is stabilized by setting the ladder stabilizer next to the rung of a ladder, adjusting the rung holder to fit the bottom rung of the ladder, and forcing the holder into the ground until the rung holder engages onto the rung and the stabilizer is securely fixed into the ground.
